(19) United States
(12) Patent Application Publication
(10) Pub. No.: US 2015/0312773 A1
(43) Pub. Date: Oct. 29, 2015

(54) SYSTEMS AND METHODS FOR PROVIDING SITE ACQUISITION SERVICES

(71) Applicants: Dhaval Joshi, West New York, NJ (US); Brian Barrett, Downers Grove, IL (US); Brijesh Shah, Skokie, IL (US)

(72) Inventors: Dhaval Joshi, West New York, NJ (US); Brian Barrett, Downers Grove, IL (US); Brijesh Shah, Skokie, IL (US)

(21) Appl. No.: 14/699,096

(22) Filed: Apr. 29, 2015

Related U.S. Application Data
(60) Provisional application No. 61/985,819, filed on Apr. 29, 2014.

(51) Int. Cl. H04W 16/18; H04W 24/02

(52) U.S. Cl. CPC H04W 16/18; H04W 24/02

(57) ABSTRACT

Systems, methods, and articles of manufacture are disclosed for providing, investigative services associated with locations for deploying infrastructure, environmental studies, audits, etc. Disclosed embodiments may be used to provide site acquisition services to telecommunication carriers, including accurate information regarding potential locations for new towers or antennas. Other project applications include interim funding, permitting, underwriting, or general project managed activities. Consistent with disclosed embodiments, a site acquisition vendor may receive a request from a client to investigate potential locations for new antennas or other equipment. The site acquisition vendor may use disclosed embodiments to quickly and efficiently generate and provide reports responsive to these site acquisition requests by assembling investigation tools for site acquisition requests, providing mobile access to these tools in the field, and capitalizing on previously collected information for potential candidate locations. Furthermore, disclosed embodiments may collect non-site acquisition related data to provide analyses for other data collection scenarios.

### CROSS-REFEERENCE TO RELATED APPLICATION 35 USC §119(e)

Benefit is claimed of the previous filed provisional application identified as U.S. provisional application for patent 61/985,819 filed on Apr. 29, 2014, by the same inventor(s), which is hereby incorporated by reference, claiming priority.

### FIELD OF INVENTION

The disclosed embodiments generally relate to providing intelligent logistics and operational services related to leasing, procuring, financing, engineering, constructing and operating considerations for locating and placement of infrastructure facilities. By way of example, the embodied services are applicable in performing site acquisition services to telecommunication carriers and, in particular, providing telecommunication carriers with accurate information regarding potential locations for new telecom towers or antennas. Disclosed embodiments, however, are not limited to site acquisitions services and may, in fact, be applied to investigations associated with sites (existing or potential) for deploying any technology infrastructure, environmental studies, site audits, etc.

### BACKGROUND OF INVENTION

Wireless telecommunication carriers continuously seek to improve and expand their wireless networks to improve service for their customers. For example, carriers often expand network coverage into new geographic areas or strengthen their wireless network in geographic areas where only limited coverage exists. This process typically involves placing new antennas on new or existing antenna towers or other structures when available. Carriers often hire vendors to investigate potential locations for these new antennas. This includes identifying potential locations within an area identified by the carrier for the new antenna(s), visiting the location, determining any restrictions or conditions for using the location, and reporting the results back to the carrier.

Engineers, project managers, delivery managers, construction supervisors, auditors, real estate property manages, regulators and investors also collect, analyze and utilize data and other information contained in these results.

Much of the investigation regarding potential locations occurs at the location in question (i.e. “in the field”). Despite this, the results of the investigation are manually entered and formatted to meet the carrier's needs after the location visit has ended. Other users, combine, extract, supplement and analyze these results to support decisions related to financial, technical and operational considerations. This manual entry and retrieval system, and constant manipulation of data within the system, leads to inefficiencies and increased errors. For example, because the field agent must rely on location information reviewed at the office, the field agent may inadvertently choose a location from the field that falls just outside of the area identified by the carrier, resulting in a wasted effort and significant delays in identifying non-compliant potential locations. Due to a lack of access to necessary tools in the field, agents must also manually enter the collected information after returning from the field, which regularly results in errors associated with typographical mistakes, poor note taking, faulty memory, etc. Further, if the investigating agent failed to collect—or lost information collected—required by the carrier, the field agent must make a second, time-consuming trip to the location.

Accordingly, a need exists to provide carriers, vendors and the professionals performing work tasks related to collecting and reporting such information with an efficient and accurate site acquisition tools that allow agents to input information as they gather it in the field into a format required by the carriers and vendors such that requested site reports may be immediately generated with reliable content.

Currently, engineering, operations, construction, financial, negotiating, real estate and project management skills are necessary to properly gather, assimilate and apply the data collected in the typical site acquisition process. The systems and methods presented herein simplify and enhance the techniques used today by these professional and trades persons.

Today, persons (i.e., engineers, real estate professionals, construction supervisors, auditors, etc.) and entities (i.e., carriers, equipment suppliers, integrators, regulators, etc.) engaged in site acquisition services combine the use of commercially available software tools including word processors, spreadsheets, databases and wireless devices to schedule activities, make and record observations, assimilate data and generate reports. These existing tools may be off the shelf or customized; but, rarely are these tools automated, integrated and enhanced with intelligent adaptation techniques or governed by an automated systems and methods framework to ensure quality control, consistency and scalability across multiple simultaneous users and multiple locations.

The system and method described herein presents a coordinated process which is used to observe, collect and report information necessary to complete the site acquisition, audit and build-out of infrastructure facilities which provides for flexible data structuring, automation, coordination, aggregation, supplementation, audit and reporting of information related to site acquisition.

The features presented in the present embodiment provide for real-time data interaction and enhanced web-portal accessibility as additional benefit for the system user.

Currently, the industry offers several field services applications to assist technicians in performing duties such as providing access to information digitally about projects and jobs in the field, input customer issues and task remediation from mobile devices and provide data to various parties in real-time basis from the field.

An existing mobile field technician application is available that assists technician to address customer needs in the field via mobile devices to troubleshoot and collect information regarding remediation.

Another existing application that provides job details, related tasks, and easy mapping capabilities for a technician to operate in the field.

Still yet another field services application that allows technicians to view active jobs and communicate with different parties from the ground with real-time cloud based data exchange.

Although there are several apparatuses which may have various functions related to the Systems and Methods for Providing Site Acquisition Services, none of these either separately or in combination with each other, teach or anticipate the current invention. Therefore, there remains an unmet need in the field of site acquisition to include intelligent field data collection and assimilation, auto-sensing network protocol adaptations, automatic file formatting and storage, automatic data upload, quality control and scheduling related to site acquisition services. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

A system is disclosed for providing site acquisition services comprising a memory storing instructions, and at least one processor configured to execute the instructions to perform operations. For example, the system may receive, from a system associated with an entity (i.e., carrier, supplier, supervisor, regulator, bank, etc.) a request for candidate locations meeting a first set of request criteria. The system may also generate a project profile based at least on the request and one or more pre-defined preferences associated with the entity, and identify at least one potential candidate location responsive to the request. The system may further generate one or more investigation tools associated with the project profile based on the request criteria and one or more characteristics of the at least one potential candidate location. The system may receive, from a computing device geographically located at a candidate location from among the at least one potential candidate location, investigation information reflecting one or more characteristics of the candidate location. The system may also generate a report responsive to the request based at least on the project profile and received investigation information, and provide the report to the entity.

Additionally, the system may also utilize any accessible wireless or wireline network to connect the local data collection device to the remote data storage device to transmit the information observed at the candidate location to the remote storage and information aggregation device. The system may have integrated network protocol auto-sensing features which provides additional parameters related to network protocol, transmission bandwidth, reliability, throughput and other information based on knowledge based on networking standards such as IEEE, 3GPP, etc.; which, by function of the present invention, redefines file type, size, configuration, resolution, priority, density, inclusion and completeness for the data set required; and which, assembles the information set required for fast, efficient and reliable transmission over the available network.

The system may also have integrated a scheduling feature, which may incorporate additional systems to combine the field based local data collection device location, proximity to known other locations, boundaries, geographic features and others like this to modify the data set to be observed, collected and reported.

Additionally, the system may have integrated quality control features which store and applies an entity's predetermined guidelines and objective criteria which the system or system operator will use to compare and contrast observed and reported data stored locally on the local data collection device and remotely on the remote data storage device. Using the compare and contrast parameters, the system features perform quality assurance analysis, which may be in real time, to alert the system operator of defects in data. Additional functions perform mean opinion scoring computations to use in decision analysis to accept or reject the content denoting the basis for the recommended action above. Such analysis in real time increases operating efficiency by ensuring that the quality of the data set collected and reported is compliant with acceptable standards for the entity.

The invention described herein automates the end to end site acquisition data preparation process which occurs after the field visit data collection activity is performed using the local data collection device and subsequently transfers the available data in a real-time basis to the remote data storage device, making the data accessible to the system users.

A automated location selector is an apparatus that is used to automatic activities, yet not restrict users from performing work while applying learned experience; provide alerts to non-conforming inputs, yet remain flexible to allow users to manage application of exceptions; and, should aid the user by prompting the user with proactive recommendations based on other known information while allowing the user to proceed according to the users discretion regarding the prompt. For example:
Automated suggestions—it is possible for the system to prompt the agent with acceptable data fill options which the agent can select or override based on training, experience and local circumstances. Based on this training, experience and local circumstances, the agent can determine the right decision to make.
Filtering—System may inform the agent when a location is selected yet that location is not suitable, based on criteria defined by the client or based on factors defined in the system based on experience, e.g. No residential area, no school property, not within flood known zone, protected lands or within close proximity to the airport, etc.
Known Suitable Alternatives—System may automatically prompt the agent with a candidate location that may be suitable by showcasing existing towers, other candidate locations previously captured but not used, or locations that are suitable such as a church facility, water tank, an existing building of suitable height, etc.

It is yet another object of the present invention to provide for an enhanced information data set suitable for the system users to search for, discover, collect and provide reporting data simultaneously to a multitude of users in real-time basis, while combining, filtering, formatting and reporting relevant information to multiple constituents.

There are several methods currently used today by professional, suppliers, carrier or entities. After more than 30 years, the industry has developed a broad array of techniques for performing site acquisition. However, the modernization of these processes has been limited and has yet to be fully integrated as presented in this embodiment. The present invention does not alter or disable this functionality of the industry to utilize its existing ways-of-working, yet it does present an enhanced and simplified system for performing site acquisition services.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures. The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIG. 2 illustrates an exemplary computing device consistent with disclosed embodiments;

FIG. 3 is a flowchart of an exemplary site acquisition process, consistent with disclosed embodiments;

FIG. 4 is a flowchart of an exemplary project creation process, consistent with disclosed embodiments;

FIGS. 5A-5B are a flowchart of an exemplary field agent investigation process, consistent with disclosed embodiments;

FIG. 6 is a flowchart of an exemplary report generation process, consistent with disclosed embodiments;

FIG. 7 is a flowchart of an exemplary workflow process applicable to the agent collecting data using the remote data collection device consistent with disclosed embodiments;

FIG. 8 illustrates an exemplary data transmittal system consistent with disclosed embodiments;

FIG. 9 illustrates an exemplary data augmentation system consistent with disclosed embodiments;

FIG. 10 illustrates an exemplary imaging system consistent with disclosed embodiments;

FIG. 11 illustrates an exemplary data analytics system consistent with disclosed embodiments; and,

FIG. 12 illustrates an exemplary data virtualization system consistent with disclosed embodiments;

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

Reference will now be made in detail to disclosed embodiments, examples of which are illustrated in the accompanying drawings. Wherever convenient, the same reference numbers will be used throughout the drawings to refer to the same or like parts. Additional details of the disclosed embodiments are also described in Attachments A-B.

Generally, disclosed embodiments are directed to systems and methods for providing site acquisition services to telecommunication carriers and, in particular, systems and methods for providing telecommunication carriers with accurate information regarding potential locations for new telecom towers or antennas. Thus, for ease of discussion, embodiments will be described in connection with the investigation of potential locations for new antennas in a wireless network responsive to a request from a telecom provider. It is to be understood, however, that disclosed embodiments are not limited to site acquisitions in the telecommunication industry and may, in fact, be applied to investigations of potential project sites in any industry. For example, disclosed embodiments may be used in investigations of sites for deploying any other technology infrastructure, environmental studies, site audits, etc.

Features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

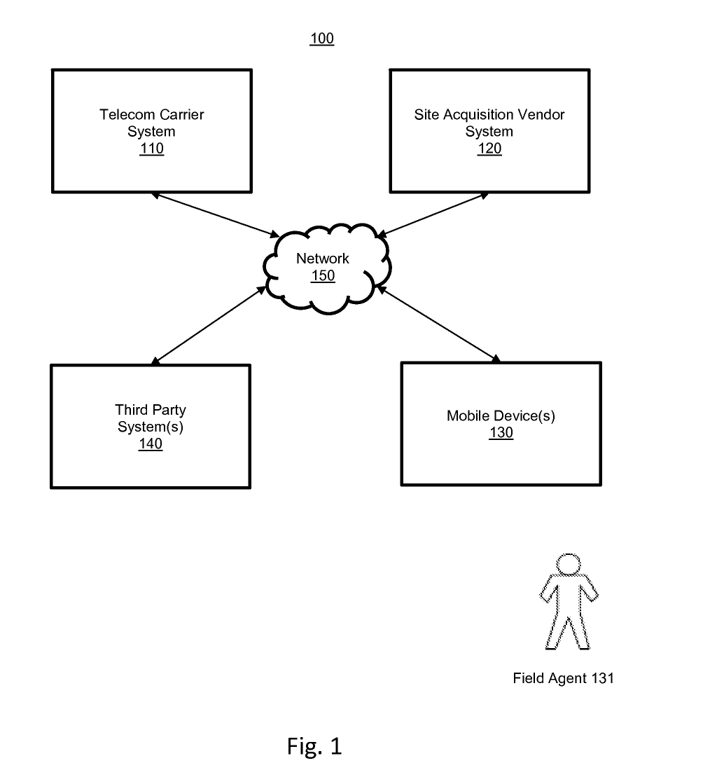

FIG. 1 illustrates an exemplary system 100 consistent with disclosed embodiments. In one aspect, system 100 may include a telecom carrier system 110, site acquisition vendor system 120, one or more agent mobile devices 130, one or more third party systems 140, and network 150.

Telecom carrier system 110 may be one or more computing systems associated with a telecommunications carrier, digital antenna system provider, private network provider, or other entity associated with technology infrastructure configured to execute software instructions stored on one or more memory devices to perform one or more operations consistent with the disclosed embodiments. For example, such a telecommunications carrier may comprise one or more entities that configure, offer, provide, and/or manage telecommunication networks, including wireless telecommunication networks. In one aspect, telecommunications carrier may update and/or improve its telecommunication network by placing new antennas on existing towers—i.e., elevated structures associated with cellular telephone sites—or other structures suitable for attaching telecommunications equipment, such as building rooftops, church steeples, etc. In other aspects, telecommunications carrier may build new towers for the antennas. In either case, according to some embodiments, telecommunications carrier may outsource the investigation of potential locations for these new antennas to one or more site acquisition vendors. Consistent with disclosed embodiments, telecom carrier system 110 may include other components and infrastructure not shown that enable it to perform operations, processes, and services consistent with telecommunications carriers.

Site acquisition vendor system 120 may be one or more computing systems associated with a site acquisition vendor, site study contractor, infrastructure provider, maintenance operator, etc. configured to execute software instructions stored on one or more memory devices to perform one or more operations consistent with the disclosed embodiments. The site acquisition vendor may comprise one or more entities that investigate potential locations for new antennas or other telecommunications equipment. In one aspect, site acquisition vendor may identify potential locations for placing telecommunications equipment satisfying particular criteria set by the telecommunications carrier, such as locations suitable for placing a new antenna within a defined radius of a provided set of geographic coordinates. According to some embodiments, site acquisition vendor may investigate the feasibility of placing antennas at locations within the geographic area indicated by the telecommunications carrier based on any applicable government restrictions (such as, for example, zoning and/or permit requirements), leasing information (with respect to, for example, the land, building, existing tower or other structure associated with a candidate location, etc.), compliance with business cases of the telecommunications carrier (i.e., a company policy not to lease space from other companies, or the like), topography (i.e., above a certain elevation, etc.), environmental (i.e., line of sight is not obscured by trees, or the like), etc.

In some embodiments, site acquisition vendor system 120 may include one or more web servers that execute software that generates, maintains, and provides web site(s), Application Programming Interfaces (APIs), and/or remotely accessible software applications over network 150. In other aspects, a site acquisition vendor system 120 may connect separately to web server(s) or similar computing devices that generate, maintain, and provide the same or similar services for the site acquisition vendor.

In certain aspects, a user may operate one or more components of site acquisition vendor system 120 to perform one or more operations consistent with the disclosed embodiments. In one aspect, such a user may be an employee of, or associated with, site acquisition vendor system 120 (e.g., someone authorized to use computing systems of site acquisition vendor system 120 or perform processes for site acquisition vendor system 120). In other aspects, the user may not be an employee of, or otherwise is associated with, site acquisition vendor system 120. According to some embodiments, a user may remotely access site acquisition vendor system 120 via, for example, mobile device(s) 130 .

Mobile device(s) 130 may represent a system associated with a user, such as field agent 131. Mobile device(s) 130 may include one or more components that perform processes consistent with the disclosed embodiments. For example, mobile device(s) 130 may be a laptop, a netbook, mobile device (e.g., tablet, smart phone, etc.), and any other type of mobile computing device configured to execute software instructions programmed to perform aspects of the disclosed embodiments. According to some embodiments, mobile device(s) 130 may access site acquisition vendor system 120 (via, for example, a web site, API, or the like) and perform processes consistent with disclosed embodiments. For example, consistent with disclosed embodiments, site acquisition vendor system 120 may be configured to provide information to and receive information from field agent 131 associated with the investigation of potential locations for placing telecommunications equipment satisfying particular criteria set by a telecommunications carrier.

In one embodiment, one or more users (i.e., field agent 131) may use mobile device(s) 130 to perform one or more operations consistent with the disclosed embodiments. In one aspect, field agent 131 may be an employee of site acquisition vendor system 120. For example, field agent 131 may be an employee tasked with conducting off-site investigations (i.e., investigations without internal access to site acquisition vendor system 120). In one embodiment, field agent 131 may remotely provide site acquisition vendor system 120 (via, e.g., mobile device(s) 130 and network 150) with information collected at the site of potential locations for placing telecommunications equipment. For example, field agent 131 may collect (via, e.g., agent mobile devices 130) pictures or videos, observable location and/or structural information, information obtained through landlord interviews, zoning information collected from a government office local to a potential location, or any other information associated with a potential location. Although the following description of disclosed embodiments may refer to field agent 131 as an “individual,” it is to be understood that the same description applies to multiple field agents acting in concert with each other or users of site acquisition vendor system 120 in the manner described above.

Third party system(s) 140 may be one or more computing systems associated with third parties configured to execute software instructions stored on one or more memory devices to perform one or more operations consistent with the disclosed embodiments. The third parties may comprise one or more entities having access to information relevant to site acquisition. For example, third parties may include entities associated with mapping technology (Google™, MapQuest™, etc.), flooding data (FEMA flood maps, etc.), topographical maps, protected land maps, airports and other jurisdictional data (i.e., government data regarding city and county limits), antenna/tower locations (collected by telecom carriers, for example). According to some embodiments, data stored by the third parties may be remotely accessible to other components of system 100, including telecom carrier system 110, site acquisition vendor system 120, and mobile device(s)130.

Network 150 may be any type of network configured to provide communications between components of system 100. For example, network 150 may be any type of network (including infrastructure) that provides communications, exchanges information, and/or facilitates the exchange of information, such as a Local Area Network (LAN), a Wide Area Network (WAN) including the Internet, or other suitable connection(s) that enables the sending and receiving of information between the components of system 100. Further, network 150 may be a single network or a combination of networks and may reflect a single type of network or a combination of different types of networks, such as the Internet and public exchange networks for wireline and/or wireless communications. Network 150 may also utilize cloud computing technologies that are familiar in the marketplace.

In other embodiments, one or more components of system 100 may communicate directly through a dedicated communication link(s), such as links between telecom carrier system 110, site acquisition vendor system 120, mobile device(s) 130, and third party system(s) 140.

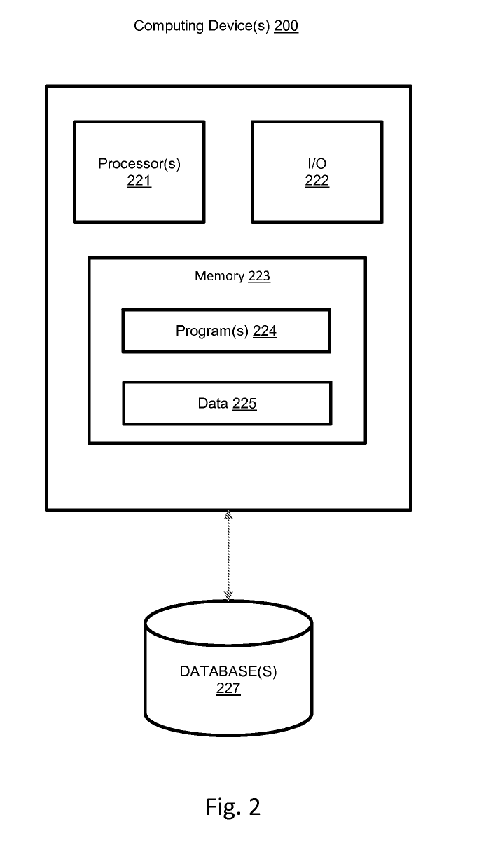

FIG. 2 shows an exemplary computing device(s) 200 consistent with disclosed embodiments. Although computing device(s) 200 may be depicted and described herein as a component of site acquisition vendor system 120, computing device(s) 200 or variations thereof may be used alternatively or additionally by telecom carrier system 110, mobile device(s) 130, third party system(s) 140, and/or other components of system 100 (shown and not shown) to perform processes consistent with disclosed embodiments.

In one embodiment, computing device(s) 200 may include one or more processors 221, one or more memories 223, and one or more input/output (I/O) devices 222. Computing device(s) 200 may take the form of a server, general purpose computer, a mainframe computer, or any combination of these components. In certain embodiments, computing device(s) 200 (or a system including computing device(s) 200) may be configured as a particular apparatus, system, and the like based on the storage, execution, and/or implementation of the software instructions that perform one or more operations consistent with the disclosed embodiments. Computing device(s) 200 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems or any other providers. Processor 221 may include a single core or multiple core processor system that provides the ability to perform parallel processes simultaneously. For example, processor 221 may be single core processors configured with virtual processing technologies known to those skilled in the art. In certain embodiments, the processors may use logical processors to simultaneously execute and control multiple processes. Processor 221 may implement virtual machine technologies, or other similar known technologies to provide the ability to execute, control, run, manipulate, store, etc. multiple software processes, applications, programs, etc. In some embodiments, processor 221 may include a multiple-core processor arrangements (e.g., dual or quad core) configured to provide parallel processing functionalities to enable computer components of system 100 to execute multiple processes simultaneously. Other types of processor arrangements could be implemented that provide for the capabilities disclosed herein. The disclosed embodiments are not limited to any type of processor(s) configured in computing device(s) 200.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of computing device(s) 200, or program 224 could comprise multiple programs. Additionally, processor 221 may execute one or more programs located remotely from computing device(s) 200. For example, telecom carrier system 110, site acquisition vendor system 120, mobile device(s) 130 , and/or third party system(s) 140, may, via computing device(s) 200, access one or more remote programs that, when executed, perform functions related to certain disclosed embodiments.

Memory 223 may also store data 225 that may reflect any type of information in any format that the system may use to perform operations consistent with the disclosed embodiments.

I/O devices 222 may be one or more device that is configured to allow data to be received and/or transmitted by computing device(s) 200. I/O devices 222 may include one or more digital and/or analog communication devices that allow computing device(s) 200 to communicate with other machines and devices, such as other components of system 100.

Computing device(s) 200 may also be communicatively connected to one or more database(s) 227. Computing device(s) 200 may be communicatively connected to database(s) 227 through network 150. Database 227 may include one or more memory devices that store information and are accessed and/or managed through computing device(s) 200. By way of example, database(s) 227 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, computing device(s) 200 may include database 227. Alternatively, database 227 may be located remotely from computing device(s) 200. Database 227 may include computing components (e.g., database management system, database server, etc.) configured to receive and process requests for data stored in memory devices of database(s) 227 and to provide data from database 227.

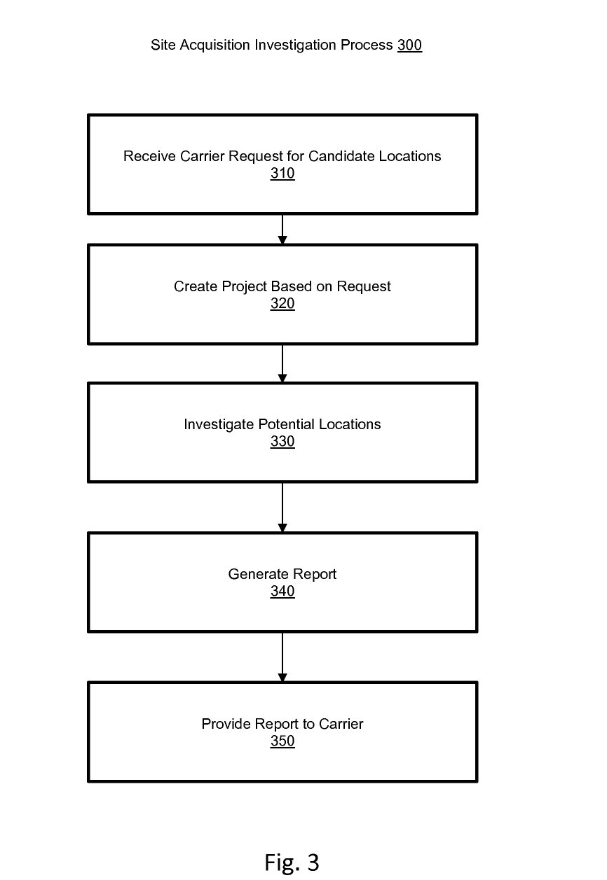

FIG. 3 illustrates an exemplary site acquisition investigation process 300, consistent with disclosed embodiments. At step 310, site acquisition vendor system 120 may receive a request for candidate locations from, for example, telecom carrier system 110 via known methods (e.g., electronic form submission, e-mail, telephone or other verbal request, etc.). The request may include, among other things, criteria for potential locations to place new antennas in a wireless network. In some embodiments, the request may require that the candidate locations include only locations with existing structures, locations falling within a “search ring” defined by a radius from a provided set of geographic coordinates (i.e., within 0.5 miles of 38° 57′ N, 77° 21′ W, or the like), locations outside of a particular county even if within the defined radius, etc. Telecom carrier system 110 may also require site acquisition vendor system 120 to provide a certain (or minimum) number of candidate locations in response to the request.

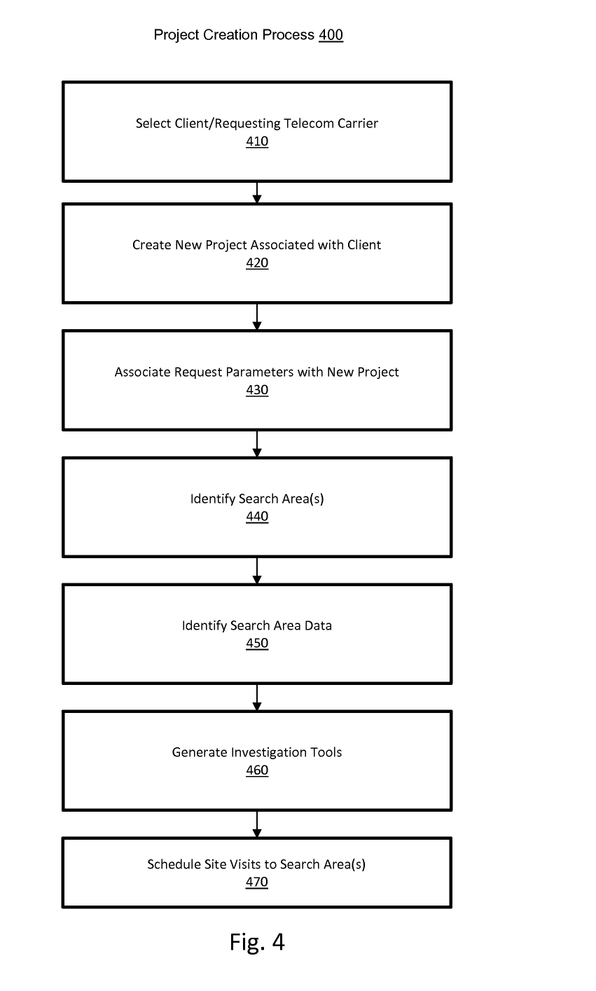

Site acquisition vendor system 120 may create a project based on the received request for candidate locations (step 320). According to some embodiments, site acquisition vendor system 120 may use a project to define the parameters set by a request for candidate locations, such as one or more search rings identified by the request. A project may also include any predefined parameters associated with the underlying telecom carrier, such as a preference to use existing structures when available. Site acquisition vender system 120 may also define user access, allocate server and/or database resources, etc. based on the created project. Further detail regarding step 320 is provided below in FIG. 4.

Site acquisition vendor system 120 may also initiate the investigation of potential candidate locations responsive to the request (step 330). For example, site acquisition vendor system 120 may determine whether field agents have already collected information regarding potential locations within the search radius defined by the telecom carrier. According to some embodiments, site acquisition vendor system 120 may flag or otherwise associate any such previously investigated locations for subsequent review and potential inclusion as a candidate location responsive to the request. Additionally or alternatively, site acquisition vendor system 120 may forward details associated with the request—including access to the appropriate project—to mobile device 130 for review and on-site investigation by field agent 131.

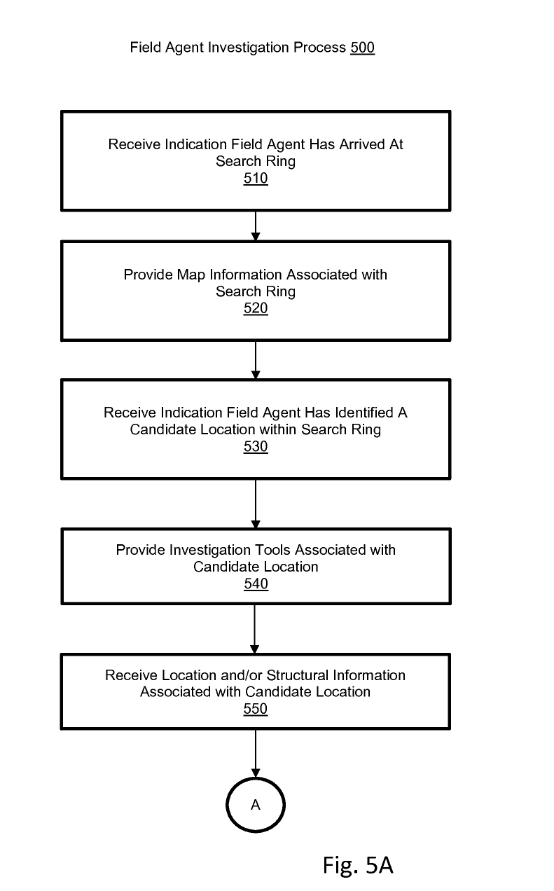

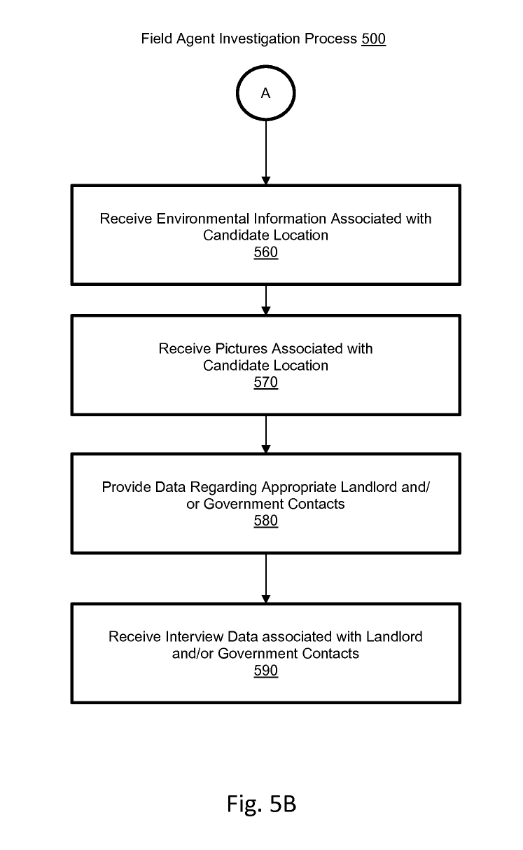

Field agent 131 may travel to the one or more search rings and visit potential candidate locations within the one or more search rings. Field agent 131 may operate mobile device 130 at the potential candidate locations to access project details and/or investigation tools, including generated forms, questionnaires, maps, etc. Field agent 131 may operate mobile device 130 at the potential candidate locations to provide data regarding those locations to site acquisition vendor system 120 for storage and association with the appropriate project and candidate location. Further detail regarding step 330 is provided below in FIGS. 5A-B, below.

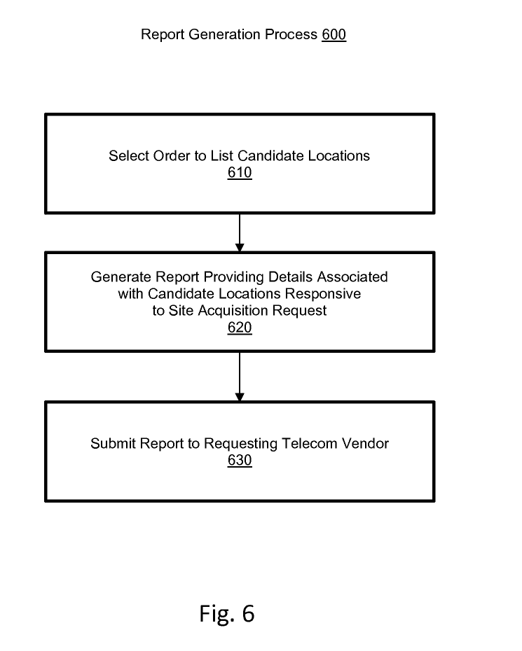

Site acquisition vendor system 120 may also generate a report reflecting the results of the investigation (step 340). In some embodiments, site acquisition vendor system 120 may access all collected data associated with responsive candidate locations and generate a report in a format expected by the telecom carrier. Further detail regarding step 340 is provided below in FIG. 6, below. Site acquisition vendor system 120 may also provide the generated report to telecom carrier system 110 (step 350).

FIG. 4 illustrates an exemplary project creation process 400, consistent with disclosed embodiments. According to some embodiments, project creation process 400 may correspond to step 320, discussed above. At step 410, site acquisition vendor system 120 may receive a selection of a client (i.e., telecom carrier) associated with the request for candidate locations. If site acquisition vendor system 120 does not have a record (i.e., profile) associated with the requesting telecom carrier, site acquisition vendor system 120 may create a new client profile. According to some embodiments, a client profile may define the telecom carrier name (AT&T, Sprint, etc.) and one or more characteristics of the client, such as the wireless network protocols (i.e., 3G, 4G, WiMAX, 802.16m, etc.) on which the client operates, client company policies on site acquisition, one or more pending and/or past projects, and the like. Upon receiving a client selection, site acquisition vendor system 120 may receive a request to create a new project for the selected client (step 420).

At step 430, site acquisition vendor system 120 may associate the request criteria for potential locations, as well as any generated materials (questionnaires, maps, etc.), with the created project. For example, site acquisition vendor system 120 may receive request criteria inputted by a user of site acquisition vendor system 120. Alternatively or additionally, site acquisition vendor system 120 may extract request criteria directly from the request via, for example, OCR technology, screen scraping, use of pre-defined fields in a CSV file, or any other suitable method of data extraction known to those of skill in the art.

At step 440, site acquisition vendor system 120 may identify one or more search areas associated with a carrier request. In some embodiments, site acquisition vendor system 120 may identify and/or map the search ring defined by a radius from a provided set of geographic coordinates. Site acquisition vendor system 120 may also identify government jurisdictions (towns, cities, counties, etc.) that constitute or fall within the one or more search areas associated with the carrier request.

Site acquisition vendor system 120 may also identify search area data implicated by the search ring, such as government restrictions, topography data, information regarding existing tower locations, and such other data impacting antenna placement decisions relevant to the identified search area (step 450). According to some embodiments, site acquisition vendor system 120 may access internal or external data sources (such as, for example, database 227) to identify relevant search area data. Additionally or alternatively, site acquisition vendor system 120 may access third party systems 140 (for example, FEMA flood data, zoning requirements, etc., stored by other systems) for such information.

Based on the identified search area data, site acquisition vendor system 120 may generate investigation tools such as questionnaires, maps, map overlays that include relevant information, route planning, location-based alerts, and/or other tools associated with candidate location investigations (step 460). For example, site acquisition vendor system 120 may generate forms listing all questions needing answers in order to prepare a candidate location report complying with the requesting telecom carrier's standards and requirements. Attachment A includes exemplary forms generated by site acquisition vendor system 120, consistent with disclosed embodiments. Site acquisition vendor system 120 may also generate maps associated with the project, such as street maps indicating the location of one or more search rings associated with a project. Attachment A also includes exemplary street maps indicating each of the one or more search rings of a project consistent with disclosed embodiments. Field agent 131 may access the created project to review (via mobile device 130 or directly from site acquisition vendor system 120) the investigation tools in order to, for example, plan a travel itinerary to visit all search rings associated with the project. In other embodiments, site acquisition vendor system 120 may generate a travel route for field agent 131 based on, among other considerations, the location of the identified search rings. Site acquisition vendor system 120 may generate maps to notify an agent that a particular location is unusable and not ideal due to certain restrictive factors. Site acquisition vendor system 120 may also provide mechanisms to overlay images depicting deployed technology over images of potential project location to show, for example, how a tower or antenna would appear a particular site using known augmented reality techniques.

At step 460, site acquisition vendor system 120 may schedule site visits associated with the search rings of the project. In some aspects, site acquisition vendor system 120 may receive scheduling information from field agent 131 (via, e.g., mobile device 130 and/or systems internal to site acquisition vendor system 120). In other embodiments, site acquisition vendor system 120 may identify dates for field agent 131 to visit potential candidate locations based on, for example, field agent 131 availability, government holiday schedules, normal business hours of operation, known available time slots of landlords and/or government office employees for an interview, and the like. For example, site acquisition vendor system 120 may access the electronic calendars of persons associated with the investigation (field agent 131, landlords associated with potential candidate locations, employees of the local zoning board(s), etc.) to identify an optimal travel schedule for field agent 131 to visit the one or more search rings.

FIGS. 5A-5B illustrates an exemplary field agent investigation process 500, consistent with disclosed embodiments. According to some embodiments, field agent investigation process 500 may correspond to step 330, discussed above. At step 510, site acquisition vendor system 120 may receive an indication that field agent 131 has arrived at one of the search rings. For example, site acquisition vendor system 120 may receive GPS coordinates or other location information from mobile device 130. Site acquisition vendor system 120 may also provide field agent 131 (via, e.g., mobile device 130) with map information associated with the search ring (step 520). Mobile device 130 may further indicate its position on a map displayed on mobile device 130 based on the received map information and its current GPS coordinates. Thus, mobile device 130 may graphically indicate whether field agent 131 is within a search ring, located in a county excluded from consideration based on request criteria, or the like. According to some embodiments, site acquisition vendor system 120 may monitor the location of each mobile device 130 via their respective GPS coordinates, which may be assumed to represent the location of the field agent 131 associated with the mobile devices 130, such that an operator of site acquisition vendor system 120 may observe and otherwise manage the location of all field agents 130 site acquisition vendor system 120. For example, an operator may use site acquisition vendor system 120 to communicate with field agent 131 via mobile device 130 to direct one or more field agents 131 to other areas.

At step 530, site acquisition vendor system 120 may receive an indication that field agent 131 is located at a candidate location. In some embodiments, field agent may “check in” at a candidate location via mobile device 130, and mobile device 130 may provide the indication to site acquisition vendor system 120 based on the “check in.” In other embodiments, a candidate location may have been previously identified in site acquisition vendor system 120, and site acquisition vendor system 120 may determine that field agent 131 arrived at the candidate location based on location information received from mobile device 130.

Site acquisition vendor system 120 may also provide mobile device 130 with investigation tools associated with the candidate location where the field agent has checked in (step 540). The investigation tools may comprise the generated questionnaires or other forms, maps, and/or other tools discussed in step 460, above, as well as newly generated investigation tools based on, for example, field agent 131's current location (i.e., the GPS coordinates of mobile device 130). The generated investigation tools may be displayed on a display associated with mobile device 130 and manipulated by field agent 131 via an input device associated with mobile device 130. For example, mobile device 130 may receive answers to the generated questionnaires as input from field agent 131.

According to some embodiments, mobile device 130 may not allow field agent 131 to progress to a new form section or investigation tool until mobile device 130 has received input regarding all fields of a previous form investigation tool. In some embodiments, the logic for determining whether field agent 131 may progress to a new form may be based on data received from site acquisition vendor system 120 via, for example, by communicating with site acquisition vendor system 120 at each form section or accessing cached data on mobile device 130 previously received from site acquisition vendor system 120. In this way, mobile device 130 prevents field agent 131 from leaving a candidate location without providing all information required to generate a report concerning candidate locations responsive to the carrier request. Mobile device 130 may also transmit information received in response to the investigation tools to site acquisition vendor system 120. In some embodiments, for example, mobile device 130 may store the information to database 227 of site acquisition vendor system 120. In other embodiments, mobile device 130 may operate in an “offline” mode where information is received while mobile device 130 has no connection to site acquisition vendor system 120 (and/or other components of system 100) and subsequently transmitted the collected information (i.e., store the information to database 227) once a connection has been established. Furthermore, users of site acquisition vendor system 120 and one or more field agents 131 operating mobile devices 130 may simultaneously edit information associated with projects, candidate locations, etc., and have changes to such information become available to other users in real-time or substantially real-time. For example, while field agent 131 provides responses to investigation tools via mobile device 130 located at the candidate location, a user of site acquisition vendor system 120 may also input information responsive to the investigation tools and site acquisition request (based on, for example, information already known and stored by site acquisition vendor system 120 for the candidate location or information the user may obtain without visiting the candidate location).

Mobile device 130 may also receive location and/or structural information associated with a candidate location (step 550). For example, field agent 131 may enter information into mobile device 130 regarding whether the location contains an existing structure suitable for mounting a new antenna, the structure type of any existing structures (tower, building, etc.), and the like. According to some embodiments, mobile device 130 may auto-fill one or more portions of the generated tools based on, for example, mobile device 130's current GPS coordinates.

At step 560, mobile device 130 may receive candidate location environmental data. For example, field agent 131 may enter information into mobile device 130 regarding observable terrain characteristics, line-of-sight for the new antenna at the new location, etc. At step 570, mobile device 130 may capture or otherwise receive one or more pictures of the candidate location. For example, telecom carriers may require a certain number of pictures from specific viewpoints be included for each candidate location submitted in response to a site acquisition request. In some embodiments, mobile device 130 may not allow field agent 131 to proceed to a new form section or other investigation tool until all required pictures become inputted. According to some embodiments, field agent 131 may operate mobile device 130 to capture the required pictures. In some aspects, mobile device 130 may auto-fill location and/or perspective information associated with the pictures (e.g., facing South, Northwest, Southeast by South, etc. at the location where the picture was captured) into the investigation tools based on, for example, GPS and/or compass functionality associated with mobile device 130. In other embodiments, mobile device 130 may receive the location and viewpoint-direction information from field agent 131 (via, e.g., an input device associated with mobile device 130). In some embodiments, mobile device 130 may automatically name and/or tag pictures taken according to standards defined by, for example, the telecom carrier. Furthermore, mobile device 130 may resize and annotate the pictures with information such as coordinates, time of days, photograph name and other relevant and desirable information based on standards defined by, for example, the telecom carrier. According to some embodiments, pictures and other information collected by field agent 131 may be formatted according to the telecom carrier's standards by site acquisition vendor system 120 upon receiving the information from mobile device 130. Additionally or alternatively, mobile device 130 may receive pictures from other devices (such as, for example, a digital camera) and/or sources (such as, for example, pictures of the candidate site from a previous investigation already stored in site acquisition vendor system 120).

At step 580, mobile device 130 may access and display information associated with relevant landlord and/or government contacts relevant to the investigation of a particular candidate location. In some embodiments, mobile device 130 may access information on demand. In other embodiments, mobile device 130 may cache information for retrieval when network connectivity is lacking. For example, mobile device 130 may determine and display contact information for the zoning commission local to the candidate location based on, for example, GPS coordinates of mobile device 130 and zoning information stored in one or more components of system 100, such as third-party system 140. In another example, mobile device 130 may determine and display contact information for one or more landlords associated with the property and/or existing structure associated with the candidate location based on GPS coordinates of mobile device 130 and leasing information stored in one or more components of system 100.

Mobile device 130 may also receive interview data (step 590). For example, field agent 131 may conduct one or more interviews with persons having information relevant to the candidate location (landlords, local law enforcement, zoning commission personnel, etc.) and input the results of those interviews into mobile device 130.

Attachment A depicts exemplary investigation tools presented to field agent 131 by, for example, mobile device 130, consistent with disclosed embodiments. Field agent investigation process 500 may be repeated—in whole or in part—for each candidate location within the one or more search rings associated with a site acquisition request.

FIG. 6 illustrates an exemplary report generation process 600, consistent with disclosed embodiments. According to some embodiments, report generation process 600 may correspond to step 340, discussed above. At step 610, site acquisition vendor system 120 may select an order in which to list candidate locations in a report responsive to the site acquisition request received by telecom carrier system 110. In some embodiments, site acquisition vendor system 120 may select the order based on input received from a user of site acquisition vendor system 120. In other embodiments, site acquisition vendor system 120 may select the order based on predefined profile and/or system settings, such as a setting to list candidate locations in the report based on the number of encumbrances (government restrictions, leases required, etc.) associated with each candidate location.

At step 620, site acquisition vendor system 120 may generate the report responsive to the site acquisition request. In some embodiments, site acquisition vendor system 120 may generate the report into a format required by telecom carrier system 110. Alternatively, the report may be automated using API's with direct or virtual electronic conections between the host and remote data storage devices. For example, telecom carrier system 110 may require the report be provided in Excel®, PDF® or Word® format and include certain data fields or provide scripts to electronically access, query, retrieve and import data directly from the storage device. Site acquisition vendor system 120 may populate the report based on information for the candidate locations stored by site acquisition vendor system 120 (e.g., in database 227). For example, site acquisition vendor system 120 may access information associated with the project/candidate location stored in database 227 and populate the report with, for example, information received during investigation of potential candidate locations. In some aspects, site acquisition vendor system 120 may populate the report with information required by telecom carrier 110, such as an identifier for the site acquisition request, an identification of the site acquisition vendor, investigation information associated with each candidate location (tower information, pictures of the candidate site, zoning restrictions, and the like), etc. Data fields that site acquisition vendor system 120 may populate may include, but are not limited to, those depicted in Attachments A-B, consistent with disclosed embodiments.

In some embodiments, site acquisition vendor system 120 may generate items for inclusion in the report based on information for the candidate locations stored by site acquisition vendor system 120 (e.g., in database 227). For example, site acquisition vendor system 120 may generate and include in the report one or maps (including, for example, street, aerial, topographical, flood, and/or jurisdictional maps) using location, investigation data, and one or more mapping services (internal and/or services obtained through third parties such as Google Maps™). Additionally or alternatively, site acquisition vendor system 120 may also provide telecom carrier system 110 with access to all collected information provided in reports, including but not limited to: a dashboard of active projects, the status of each project and/or individual project items, etc.

At step 630, site acquisition vendor system 120 may submit the report to the telecom carrier system 110 (i.e., the requesting telecom carrier) in any suitable electronic format, including, for example, JPEGs, GIFs, PDFs, spreadsheets, videos or text files. The report may be provided by any suitable communication means, including electronic message, upload to a database associated with telecom carrier system 110, etc.

The disclosed embodiments improve upon existing site acquisition service solutions by improving both the scope, speed, and accuracy of candidate location information provided to the telecom carrier. Mistakes made during potential candidate location investigation are not easily undone and often require time-consuming returns to potential candidate locations, often hours away from the field agent's home office. Accordingly, by assembling investigation tools for site acquisition request, providing mobile access to those tools in the field, and capitalizing on previously collected information for potential candidate locations, site acquisition vendor system 120 may quickly and efficiently generate and provide reports responsive to site acquisition requests.

Other features and functionalities of the described embodiments are possible. For example, the processes of FIGS. 3-6 are not limited to the sequences described above. Variations of these sequences, such as the removal and/or the addition of other process steps may be implemented without departing from the spirit and scope of the disclosed embodiments.

Additionally, the disclosed embodiments may be applied to different types of investigations. Any service that provides investigations typically requiring on-site visits to customers may employ systems, methods, and articles of manufacture consistent with certain principles related to the disclosed embodiments.

Furthermore, although aspects of the disclosed embodiments are described as being associated with data stored in memory and other tangible computer-readable storage mediums, one skilled in the art will appreciate that these aspects can also be stored on and executed from many types of non-transitory computer-readable media, such as secondary storage devices, such as hard disks, floppy disks, or CD-ROM, or other forms of RAM or ROM. Accordingly, the disclosed embodiments are not limited to the above described examples, but are instead defined by the appended claims in light of their full scope of equivalents.

The automation provided in the present embodiment is accomplished by:
Analytics—System shall allow Telecom Carriers or such customers to compare performance of their vendors/service providers that perform services described herein. Customer can select one vendor provider and evaluate how many jobs were performed Vendor A vs. Vendor B. Customer can view a report on how fast Vendor A completed x number of projects/jobs in the same region as Vendor B. How much Vendor A charged for services vs. Vendor B for similar projects in the same region. Vendor can perform similar analysis by selecting individuals in their company for comparison purposes. It may be useful to determine how fast Person A completed x number of projects vs. Person B in the same region. Vendor may be able to analyze the time to complete jobs/projects based on historical job data to reassess time to complete new jobs and to evaluate pricing for providing similar services in the future. The system may also provide data about which jurisdiction(s) most often rejects requests for new builds. The database will store all collected data and segment data for ease for analysis. The analytics engine will analyze data correlations and interrelationship of the data to create desired report output. The analysis engine will also create predictive models that will support the automated candidate selector functionality, whereby it will notify the field representative that a particular candidate chosen by them is in a jurisdiction that has less likelihood of acceptance;
Productivity Analysis—system functionality which provides automatic benchmarks and comparison data, such as be able to benchmark productivity—how is vendor a vs. vendor b in speed, how is individual a vs. b, how fast jobs can be done in region a vs. region b, which jurisdictions are more restrictive than others;
Estimating—system functionality which provides for creating recommended cycle time estimates and project duration estimates for new tasks based on historical information collected from prior work completed;
Screen Capture—one of the time consuming part of job completion is inputting candidate information on a map (search ring) upon returning to the office. This requires an agent to visit different online mapping (e.g. Google Satellite view) and data providers (e.g. FEMA), inputting chosen candidates on the map, then scanning/cutting or pasting that information into client required form. The system herein automates that process by automatically pulling data feeds from various sources and overlaying that on a map, in addition to inputting the search ring and chosen candidate on the map with overlaid data. Once on a map page within the system, agent can simply click an add button and the system creates a screen shot of the map with all the overlaying data and stores in the database for final submission to the client;
Resource Planning—system functionality that provides for the real time tracking of individuals, jobs and assets to perform jobs;
Asset Tracking—using GPS coordinates of a mobile device, a project manager in the office can see on a map where each and individual agent is currently located in the field. In addition, equipment and vehicle used to perform jobs can be outfitted with GPS trackers to track their location on a map. This functionality allows project managers to see personnel and assets available in the field and allows them to redeploy to a new job or need that may arise in a location close to the asset;
Augmented Reality—system functionality which may be available to showcase information about the area, (i.e., visually displaying the ground view of the location where the individual is standing (typically what a map of the same location would display on paper) through the camera lens; and, overlaying the present image onto the displayed ground view in a single image captured by the camera. Agent can use device's camera to point to specific location, using GPS coordinates, the system can identify a location and pull information from various data sources (e.g. FEMA Flood Zone, Airport locator) to show a field representative information about surrounding location. For example, the system can display a church icon to show a church in a given direction to indicate it being a viable location. In other instances, agent can overlay an image of a structure (e.g. a tower) on an image coming from the camera to indicate how a given structure would look on a particular landscape. Agent can move the structure image around on the view to reposition it on the landscape. Alternatively, agent can take a picture using the camera and overlay structural information on a photograph;
Photo Stitching—Based on location of the photos and coordinates, the system can automatically stitch available photos together to create a 360 degree panoramic view of the location that be viewed within the system. Using stitched photos from the field, the system can overlay available data on top of the photo(s), to provide a virtual view of the location with all available information such as other potential non-selected candidate locations, flood zone, etc;
Workflow—system functionality that automatically schedules the invoicing system when project is completed by a vendor and submitted for approval for payment.
Virtualization—system functionality that provides a virtual view of the site, combined with the ability to stitch together a panoramic view of all the pictures from the site, that can be manipulated by mouse or touch to rotate the view 360 degrees in all axis;
Virtual reality—system functionality which provides a view to engineers on their desktop of a site when they look at site photos resulting from overlaying all of the data available through the augmented reality features where layers of data, such as flood zone, etc. are showcased in this view; and,
Data reusability—system functionality to process data into supersets or sub-set data architecture to support delivering multiple variations of similar data for each client based off of one primary data repository and metadata structure.

The present embodiment encompasses the fundamental function providing data sharing. Accordingly:
System features provide enhanced process for data reuse between projects and potentially between customers or other entities;
System features provide data storage configurations according to entity defined guidelines with scalable configuration and adaptability within the data structure format for customization as required.
System features provide data manipulation controls to allow data conversion from an existing format to a different format defined for each client or project deliverable (e.g. showing the date as Apr. 10, 2014 as opposed to Apr. 10, 2014); and,
System features that allow autonomous data exchange to share data with other customers in a manner to be defined, where appropriate.

Different telecom carriers have different requirements for data to be collected in the field. Carrier A may request 20 data points and 10 photos, while Carrier B may request 50 data points and 20 photos. The system will allow a field agent to collect superset of data that transcends what an individual carrier may require, for example, the agent may collect 40 data points and 15 pictures which take in to account common and dissimilar data points required by different carriers. However, in the backend, the system will decipher what data point is required for Carrier A vs. Carrier B. At the time of report generation, the system will identify for which carrier the report has to be generated, and convert the superset data into smaller subset required for a given carrier. In addition, the system will convert information in a format required by an individual carrier, e.g. Carrier A requires date in Month Day, Year format while Carrier B requires a date in MM/DD/YYYY format. As such, an agent will always see the data points required for all candidate location(s), i.e. the superset data, in a common and consistent format.

The superset of data collected for each candidate allows a user to select the subset data and reuse it for a given carrier requirement, e.g. A Candidate selected for Carrier A can be reused to fulfill request by Carrier B by reusing the data collected in the field instead of requiring a special site visit. Simply adding this carrier to the field.

The present embodiment is not restricted in use or application to limit an entity from following or adopting customized processes which they find necessary or desirable. Accordingly:
Customers should be able to define the data that is collected or referenced from external sources for each client or project. They should be able to re-use this data set for other clients or projects; and,
Customers should be able to define the data and format of the deliverables for a client or project. They should be able to re-use this format for other clients or projects.

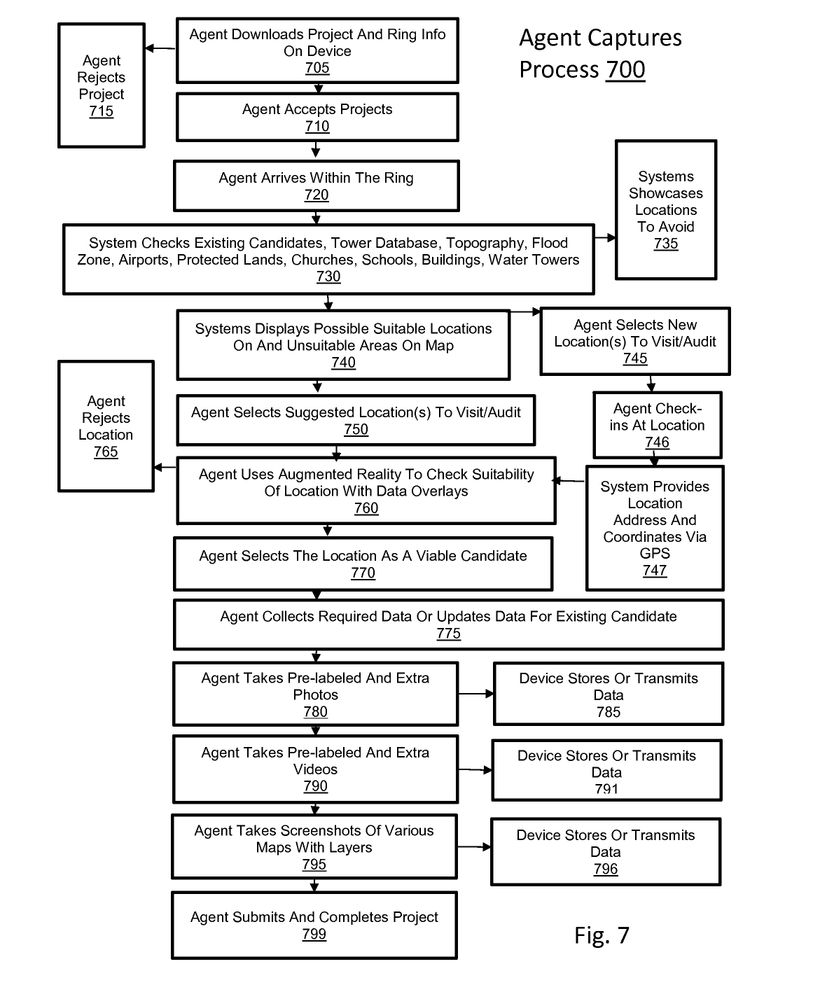

The Agent capture process 700 shown in FIG. 7 illustrates the process workflow for downloading initial project information, scope, and selection criteria as shown in step 705. The agent in step may accept 710 or reject 715 the project based on decision criteria and experience with the proposed location. The agent would proceed to the ring location 720 and begin evaluation based on criteria 730. The agent would also consider other known information 735 before considering potential candidates 740 which may be prompted to the agent by the automated function of the system.

The agent proceeds to select locations 750 and checks-in 745 using the system at the location 746 and captures the location detail 747. Using the system feature, the agent augments 760 the local data and either rejects 765 or selects the location 770 as being a viable candidate.

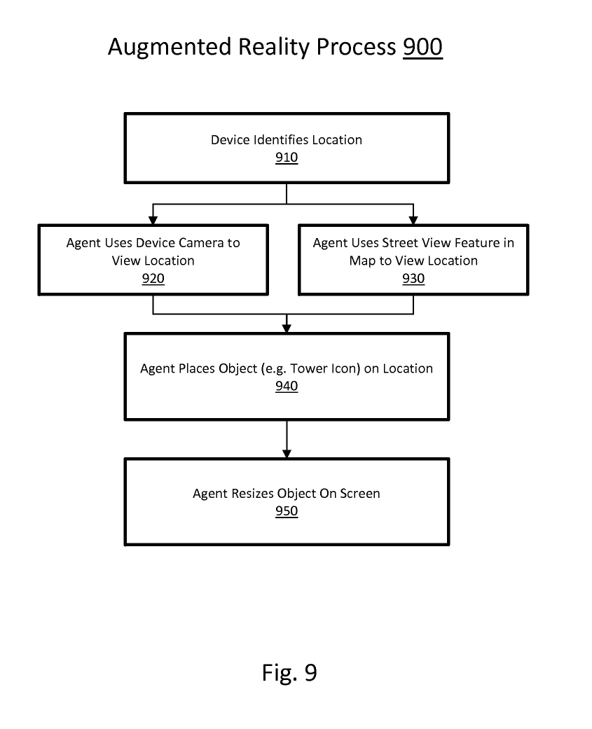

Once the agent establishes a location and checks-in 745, the Augmented Reality Process 900, shown in FIG. 9, is available to the agent. Using the device location 910, the agent can either use the camera to view the location 920 or street view feature 930 to view the location. The agent then inserts an object selected from an object library 940 to display on the view selected in 920 or 930 above. Using device controls, the agent resizes the object 950 to display the correct perspective view.

The agent then captures additional information 775, captures photographs 780, stores such images 785, captures videos where feasible 790 and stores those videos 791. The agent also captures other images with various map layers 795 and stores that data 796. In step 799, the agent submits and completes the project.

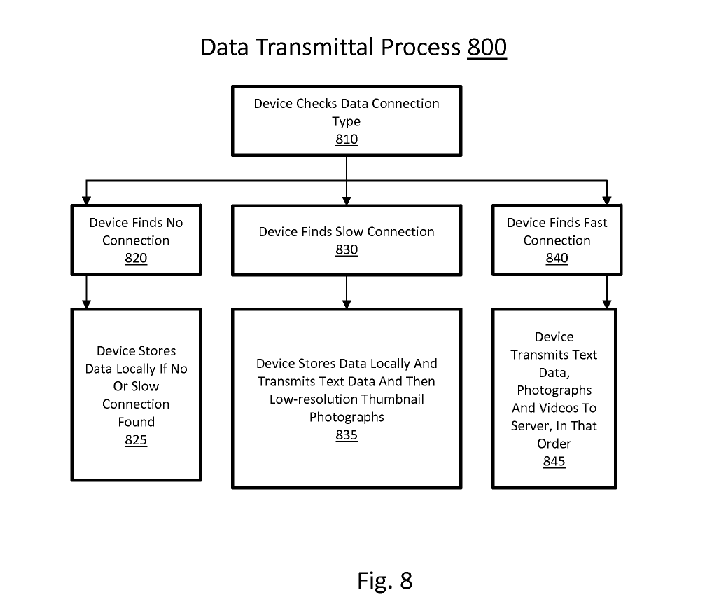

To sumbit the project 799, the agent initiates the Data Transmittal Process 800, shown in FIG. 8. Initially, the local data collection device verifies network data connectivity 810. If no network is found or if the network bandwidth is insufficient 820, the data is stored locally 825. If the network connection is available; yet the data transfer rate is slow 830, the data is reformatted and temporary files are submitted 835. If the network is found with adequate bandwidth, the complete data set is uploaded 845.

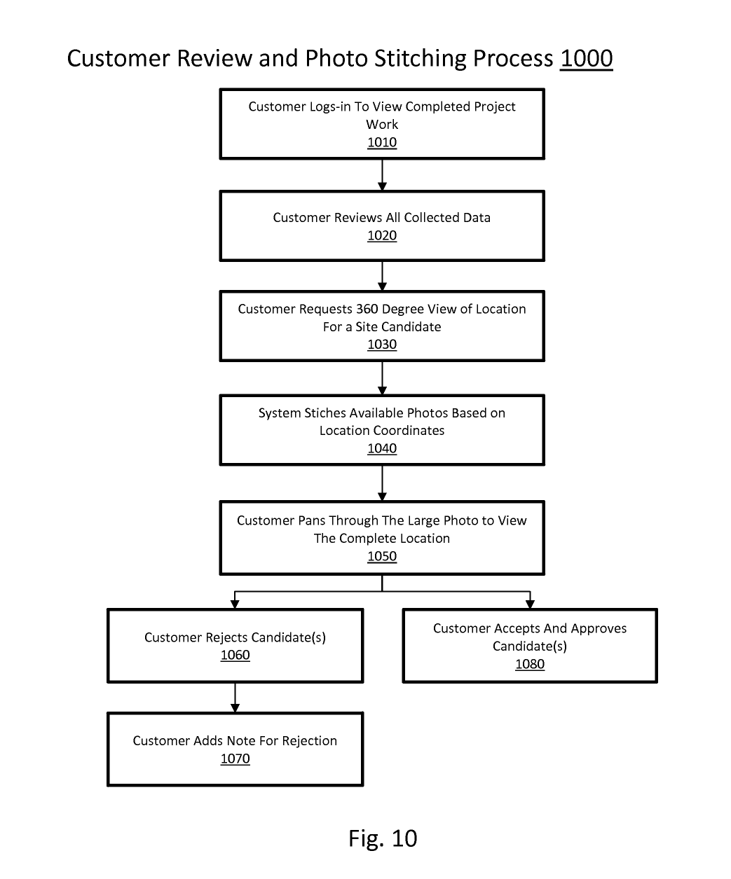

In FIG. 10, the Customer Review and Photo Stitching Process 1000 is shown, whereby a customer or entity can review the data by accessing the system 1010. All data collected and results which are generated are accessible 1020. Customer may request 360 perspective views of the data 1030, and in response the system will stitch together various perspective data to display the desired view 1040. The customer may then pan 1050 the perspective view 1040 that was generated. The customer may then reject the candidate location 1060, or accept the location 1080. If the customer rejects the location 1060, notes can be added 1070.

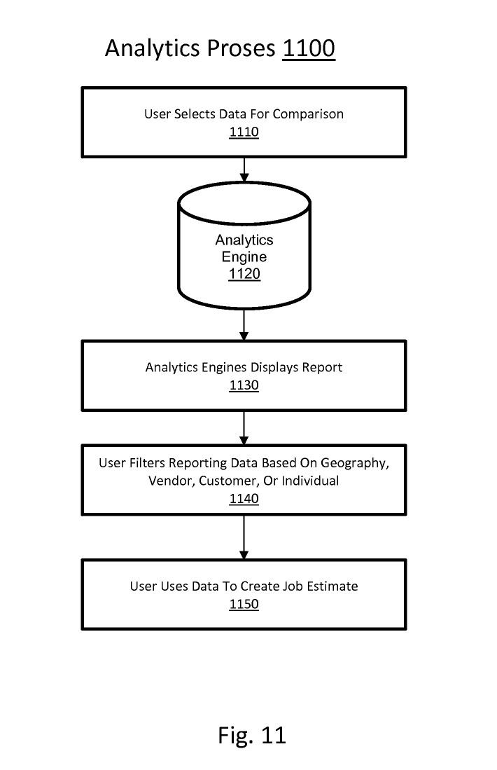

In FIG. 11, the Analytics Process 1100 is shown. Using this process 1100, the user may select data 1110 to use in comparison or for evaluation purposes. The analytics engine 1120 retrieves and extracts data and formulates new data based on analytics to display results in the form of a report 1130. Filter may be automatically applied 1140 or may be applied by the user 1140 to customize the results reported. The user may generate job estimates, completion reports and other analysis 1150 using this process 1100.

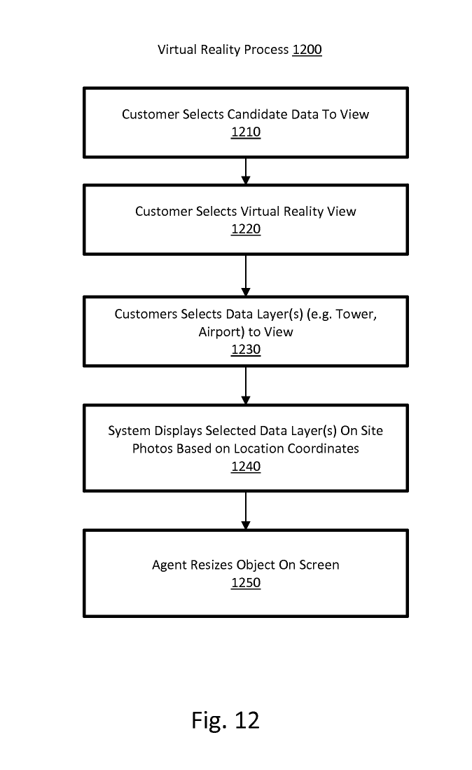

In FIG. 12, the Virtual Reality Process 1200 is shown. A customer may select a candidate once the candidate is submitted to the data store 1210. The Virtual Reality View 1220 is selected by the customer. Data layers may be added 1230. The system displays 1240 data collected, known data acquired from external sources and layer data based on the location coordinates of the candidate. Agents resize objects on screen 1250 when storing candidate information with layer data.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for providing site acquisition services, the system comprising:
a memory storing instructions; and
at least one processor configured to execute the instructions to:
receive, from a system associated with an entity, a request for candidate locations meeting a first set of request criteria;
generate a project profile based at least on the request and one or more pre-defined preferences associated with the entity;
identify at least one potential candidate location responsive to the request;
generate one or more investigation tools associated with the project profile based on the request criteria and one or more characteristics of the at least one potential candidate location;
receive, from a computing device geographically located at a candidate location from among the at least one potential candidate location, investigation information reflecting one or more characteristics of the candidate location;
generate a report responsive to the request based at least on the project profile and received investigation information; and
provide the report to the entity.

2. A system for providing site acquisition services which transfers auditable site records over data networks, the system comprising:
a memory storing instructions; and
at least one processor configured to execute the instructions to:
receive and store, from a system associated with an entity, a data record associated with a candidate locations meeting a first set of request criteria;
automatically detect connectivity to a network used for transferring electronic data from the original storage device to a remote storage device;
analyze the network protocol to configure file storage and transfer criteria accordingly to specifications embedded in the system parameters;
analyze the bandwidth and reliability of the connected network to determine file size parameters adjustments essential to reliable data transmission over the present network from the original storage device to the remote storage device;
automatically reconfigure and create temporary files according to the file size parameters to transfer temporary files reliably from the original storage device to the remote storage device;
automatically monitor changes in the network connectivity, bandwidth availability and network reliability to transmit supplemental data to data previously transmitted from the original storage device to the remote storage device until 100% of the specific data is transferred to the remote storage device.

3. The system for transferring auditable site records over a data network described in claim 2 above, which is a wireless or wireline network.

4. The system for transferring supplemental data over a data network described in claim 2 above, which is a continuous process over the same network described in claim 2 above.

5. The system for transferring supplemental data over a data network described in claim 2 above, which is a continuous process over a newly connected networks acquired at a later time.

6. The system for transferring supplemental data over a data network described in claim 2 above, which is configured to automatically adapt to various network protocol (for example 2G, 3G, 4G, LTE, etc) which are accessible to the connected original storage device.

7. A system for providing site acquisition services which automatically populates and analyzes a dynamic data set for reporting, the system comprising:
a memory storing instructions; and
at least one processor configured to execute the instructions to:
receive, from a system associated with an entity, a data files according to pre-defined criteria;
generate a data set profile based at least on the request and one or more pre-defined preferences associated with the entity;
identify the location of an original storage device and the proximity of that device to boundaries contained in pre-defined specifications for the data set;
retrieve, assess and integrate data from relevant private and public databased related to a territory defined by the boundaries determined based on the location of the original storage device;
calculate and make accessible to the original storage device, planning routes which are conforming to pre-defined criteria for such territories;
monitor ranges, known obstacles, and other criteria which are pre-determined to invalidate data collected by the original storage device and providing alerts to the original storage device controller according to per-defined criteria.

8. A system for providing site acquisition services, which continuously analyzes data stored in the remote storage device, the system comprising:
a memory storing instructions; and
at least one processor configured to execute the instructions to:
compare, from a system associated with an entity, all data files according to pre-defined criteria;
generate a data set exception profile based at least on the data received from one or many remote storage devices and one or more pre-defined preferences associated with the entity;
generate and maintain a mean opinion score according to a pre-defined criteria to base exceptions on;
recompare, from a system associated with an entity, all data files according to pre-defined criteria, exceptions and mean opinion scores, generating new or renewing existing exceptions related to the data set;
identify the location associated with the exception generated and generate an alert related to the exception with additional instructions being generated regarding overcoming the exception;
retrieve, assess and integrate data from original storage devices or other subsequent original storage devices from the appropriate location to overcome exceptions which are known.

9. A system for providing site acquisition services, which continuously analyzes data stored in the remote storage device based on contractual compliance criteria, the system comprising:
a memory storing instructions; and
at least one processor configured to execute the instructions to:
compare, from a system associated with an entity, all data files according to pre-defined financial and contractual criteria;
generate a data set exception profile based at least on the data received from one or many remote storage devices and one or more pre-defined preferences associated with the entity;
generate and maintain a checklist according to a pre-defined criteria to base exceptions on;
recompare, from a system associated with an entity, all data files according to pre-defined criteria, exceptions and financial or contractual criteria, generating new or renewing existing exceptions related to the data set;
identify the time and data associated with the exception generated and generate an alert related to the exception with additional instructions being generated regarding overcoming the exception;
retrieve, assess and integrate data from original storage devices or other subsequent original storage devices from the appropriate location to overcome exceptions which are known.
